(19) United States
(12) Patent Application Publication
(10) Pub. No.: US 2005/0157800 A1
(43) Pub. Date: Jul. 21, 2005

(54) Error concealing device and method thereof for video frame

(75) Inventor: Sung-joo Kim, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/030,128

(22) Filed: Jan. 7, 2005

(30) Foreign Application Priority Data
Jan. 19, 2004 (KR) 10-2004-0003979

(51) Int. Cl. H04N 7/12

(52) U.S. Cl. 375/240.27; 375/240.24

(57) ABSTRACT

An error concealing device and a method thereof for video frames. The device and method smooth horizontal/vertical edges, which are generated after concealing errors of a macro block in the video frames using a predetermined error concealing method, through a corresponding post-process in order to generate high quality images.

### CROSS-REFERENCE TO RELATED APPLICATION

This application claims priority from Korean Patent Application No. 10-2004-0003979 filed on Jan. 19, 2004 in the Korean Intellectual Property Office, the disclosure of which is incorporated herein by reference in its entirety.

### BACKGROUND OF THE INVENTION

1. Field of the Invention

The present invention relates to an error concealing device and a method thereof for video frames, and more particularly, to an error concealing device and a method thereof for video frames, for providing high quality images by smoothing horizontal/vertical edges that occur due to concealing of errors generated in video frames.

2. Description of the Related Art

Due to the development of digital signal processing technology, technologies to compress and transfer large amounts of moving picture data through a transfer channel of a limited bandwidth are now appearing.

In moving picture standards, such as MPEG, H.261, and H.263, a slice unit is used as a re-synchronization unit of channel errors.

Slices consist of a plurality of macro blocks, and motion compensation coding is performed in units of a 16×16 sized block in the macro blocks.

In general, a frame includes a number of slices, and the number of slices depend on the size of an image. Thus, when an error occurs to a slice in the frame, data of another slice in the frame may be lost.

Moving picture coding methods include both a variable length coding method and a motion compensation coding method. In these methods, when an error occurs in any bit of a bit stream, a large amount of video data is lost and the effect of the damaged image propagates to a number of following frames. Thus, if a bit stream transferred after being coded by such a method is decoded by a decoder, serious deterioration in image quality may occur.

In order to solve such a problem, an error concealing method of supplementing the lost data with the normally coded data around the lost data to restore the lost data to be similar to the original data is provided.

Currently, widely used error concealing methods include a spatial error concealing method of performing error concealing in a frame where an error occurs and a temporal error concealing method of performing error concealing by using video data of a plurality of frames.

These error concealing methods will now be described with reference to a digital TV receiver.

Referring to FIG. 1, a conventional digital TV receiver includes a channel decoder unit 10, a demultiplexing unit 20, a video decoder unit 30, an audio decoder unit 40, a parser 50, an error concealing unit 60, a video output unit 70, and an audio output unit 80. The channel decoder unit 10 restores digital data by performing RF demodulation and channel decoding on a received channel. The demultiplexing unit 20 demultiplexes the digital data restored in the channel decoder unit 10 to extract program information, such as video signals, audio signals, and an electric program guide. The video decoder unit 30 and the audio decoder unit 40 decode the video signals and the audio signals, and the parser 50 parses the program guide. The error concealing unit 60 conceals errors in the decoded video signals. The video output unit 70 outputs the error concealed video signals and the parsed program guide, and the audio output unit 80 outputs the decoded audio signals.

As shown in FIG. 2, the error concealing unit 60 includes an error detection unit 61, a spatial error concealing unit 62, and a temporal error concealing unit 63. The error detection unit 61 detects an error in the video signal, which is decoded in the video decoder unit 30. The spatial error concealing unit 62 and the temporal error concealing unit 63 perform spatial error concealing and temporal error concealing on the error detected by the error detection unit 61, respectively, based on the picture type of the decoded video signals.

Here, the error detection unit 61 can detect errors by examining the syntax of a bit stream, which is decoded in the video decoder unit 30, by using decoding errors, which are generated while decoding the RF signals received by the channel decoder unit 10, or by determining disharmony between a predetermined macro block and adjacent macro blocks in the video frame, which is decoded by the video decoder unit 30.

Referring to FIG. 3A, the spatial error concealing unit 62 performs spatial error concealing on a macro block 91a in which an error occurs by using adjacent macro blocks 91b, 91c, and 91d within a video frame 91.

For example, to conceal the error, the spatial error concealing unit 62 copies a normal macro block among the adjacent macro blocks 91b, 91c, and 91d to the macro block 91a containing the error.

In addition, the temporal error concealing unit 63 conceals an error by using motion vectors of prior and following frames of a present frame. Referring to FIG. 3B, the temporal error concealing unit 63 copies a macro block 93a of a prior frame 93 that is located at the same location as an error-containing macro block 92a of a present frame 92.

Typically, the spatial error concealing unit 62 is used for I-type pictures, and the temporal error concealing unit 63 is used for P-type pictures and B-type pictures.

However, the spatial error concealing method conceals errors by copying the upper and lower adjacent macro blocks of the error-containing macro block, and thus vertical edges inevitably occur.

In addition, the temporal error concealing method conceals errors through motion compensation by using the motion vectors of prior and following macro blocks of a present frame in the error-containing macro block.

In this case, an error may occur in the motion vectors anytime. Thus, an edge may occur along the boundaries of the error-containing macro block.

Accordingly, it is difficult to provide images having high quality due to the horizontal/vertical edges generated by the error concealing method.

### SUMMARY OF THE INVENTION

An exemplary embodiment of the present invention provides an error concealing device and a method thereof for video frames for providing high quality images by smoothing horizontal/vertical edges, which are inevitably generated when concealing errors in the video frames.

According to an exemplary embodiment of the present invention, there is provided an error concealing device comprising an error concealing unit concealing an error generated in a macro block of video frames by using a predetermined error concealing method, and a video post-process unit smoothing horizontal/vertical edges, which are generated in error-containing video frames.

The error concealing unit may conceal an error using a spatial error concealing method and a temporal error concealing method based on the picture type of the video frames.

The video post-processing unit may perform smoothing of pixels in the error-containing macro block that have a differential sum exceeding a reference value against adjacent pixels in a case where the error of the video frames is concealed by the spatial error concealing method.

In addition, the video post-processing unit may perform smoothing when a difference of averages of predetermined numbers of pixels, which are located at both sides of horizontal or vertical boundary between the error-containing macro block and the adjacent macro block, exceeds a reference value, in a case where the error of the video frames is concealed by the temporal error concealing method.

The differential sum Pₙ^{diff} is preferably obtained by

$${P}_{n}^{diff} = {\sum }_{k = 0}^{a} \vert {P}_{n + k} - {P}_{n + k + 1} \vert > T1 ,$$

(n=0, 8, 16, 32, . . . ), in which n denotes n^{th} pixel for performing smoothing filtering in an error concealed area by the spatial error concealing method, a denotes the number of pixels for obtaining the difference, and T1 denotes the reference value for performing the smoothing.

The average P_{abs} is preferably obtained by

$${P}_{abs} = \frac{{P}_{1} + … + {P}_{\frac{n}{2}}}{\frac{n}{2}} - \frac{{P}_{\frac{N}{2} + 1} + … + {P}_{n}}{\frac{n}{2}} > T2 ,$$

in which n denotes the number of pixels for performing deblocking filtering with reference to horizontal/vertical directions of the macro block after the temporal error concealing, and T2 denotes the reference value for performing the smoothing. Preferably, a pixel value Pₙ′ in a case where the smoothing and deblocking are performed horizontally or vertically is obtained by

$${P}_{n}^{′} = \frac{1}{b} {\sum }_{k = - c}^{c} {w}_{k} {P}_{n + k} ,$$

in which n denotes an n^{th} pixel for performing filtering horizontally or vertically, wₖ denotes a weighting factor applied to the pixel, which is used in the smoothing filtering, b denotes the sum of weighting factors wₖ, in other words,

$$b = {\sum }_{- c}^{c} {w}_{k} ,$$

and 2c+1 is a smoothing filter coefficient, and therefore c can be determined as follows:

$$c = \frac{\text{smoothing filter coefficient} - 1}{2}$$

The smoothing for the spatial error concealing method and the temporal error concealing method may be selectively used based on the picture type of a corresponding video frame in a case where the picture type of a present video frame is different from the picture types of a prior video frame and a following video frame.

According to another exemplary embodiment of the present invention, there is provided a method of concealing errors for video frames, the method comprising concealing an error generated in a macro block of video frames by using a predetermined error concealing method, and smoothing horizontal/vertical edges of the error-containing macro block.

The concealing of the error may be performed by a spatial error concealing method and a temporal error concealing method based on the picture type of the video frames.

The smoothing of the horizontal/vertical edges may include calculating a differential sum of adjacent pixels in units of a predetermined number of pixels for the error-containing macro block in a case where the error of the video frame is concealed by the spatial error concealing method, and performing smoothing when the calculated value exceeds a reference value.

The smoothing of the horizontal/vertical edges may include calculating a difference of averages for predetermined numbers of pixels located at both sides of horizontal/vertical boundaries between an error-containing macro block and the adjacent macro blocks in a case where the error of the video frame is concealed by the temporal error concealing method, and performing smoothing when the calculated value exceeds a reference value.

The differential sum Pₙ^{diff} is preferably obtained by

$${P}_{n}^{diff} = {\sum }_{k = 0}^{a} \vert {P}_{n + k} - {P}_{n + k + 1} \vert > T1 ,$$

(n=0, 8, 16, 32, . . . ), in which n denotes an n^{th} pixel for performing smoothing filtering in an error concealed area by the spatial error concealing method, a denotes the number of pixels for obtaining the difference, and T1 denotes the reference value for performing the smoothing.

The average P_{abs} preferably obtained by

$${P}_{abs} = \frac{{P}_{1} + … + {P}_{\frac{n}{2}}}{\frac{n}{2}} - \frac{{P}_{\frac{N}{2} + 1} + … + {P}_{n}}{\frac{n}{2}} > T2 ,$$

in which n denotes the number of pixels for performing deblocking filtering with reference to horizontal/vertical directions of the macro block after the temporal error concealing, and T2 denotes the reference value for performing the smoothing.

Preferably, a pixel value Pₙ′ in the case where the smoothing filtering and deblocking filtering are performed horizontally or vertically is obtained by

$${P}_{n}^{′} = \frac{1}{b} {\sum }_{k = - c}^{c} {w}_{k} {P}_{n + k} ,$$

in which n denotes an n^{th} pixel for performing filtering horizontally or vertically, wₖ denotes a weighting factor applied to the pixel, which is used in the smoothing filtering, b denotes the sum of weighting factors wₖ, in other words,

$$b = {\sum }_{- c}^{c} {w}_{k} ,$$

and 2c+1 is a smoothing filter coefficient and therefore c is determined by

$$c = \frac{\text{smoothing filter coefficient} - 1}{2} .$$

The method of concealing errors for video frames may further comprise determining whether the picture type of a present video frame is same as the picture types of prior and following video frames, and selectively using the smoothing for the spatial error concealing method and the smoothing for the temporal error concealing method when the picture types of the video frames are different.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional digital TV receiver;

FIG. 2 is a block diagram of a conventional error concealing device for video frames;

FIG. 3A illustrates a conventional spatial error concealing method;

FIG. 3B illustrates a conventional temporal error concealing method;

FIG. 4 illustrates a spatial error concealing method using a bilinear interpolation according to an embodiment of the present invention;

FIG. 5 is a block diagram of an error concealing device for video frames according to an embodiment of the present invention;

FIG. 6 illustrates a method of calculating matching of an error concealed macro block and adjacent macro blocks according to the embodiment of the present invention;

FIG. 7 illustrates pixels, which are used to calculate an average for performing a temporal post-process according to the embodiment of the present invention;

FIG. 8 is a flowchart of a method of concealing an error for video frames according to an embodiment of the present invention;

FIG. 9 illustrates a smoothing method performed by a spatial post-processing unit according to an embodiment of the present invention; and

FIG. 10 illustrates a smoothing method performed by a temporal post-processing unit according to an embodiment of the present invention.

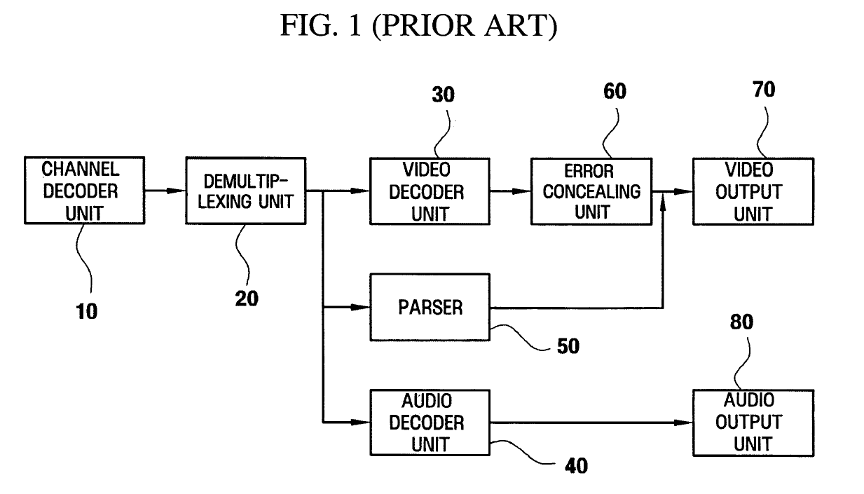

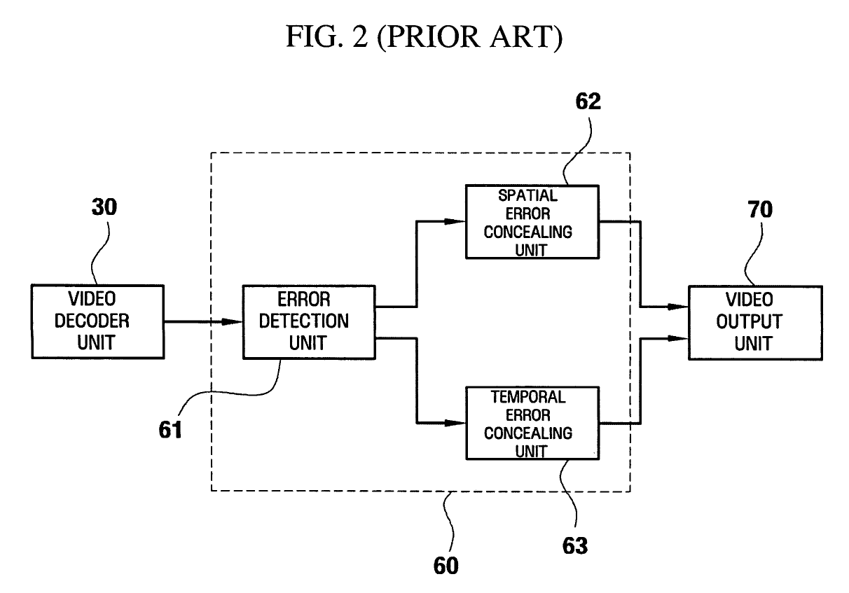

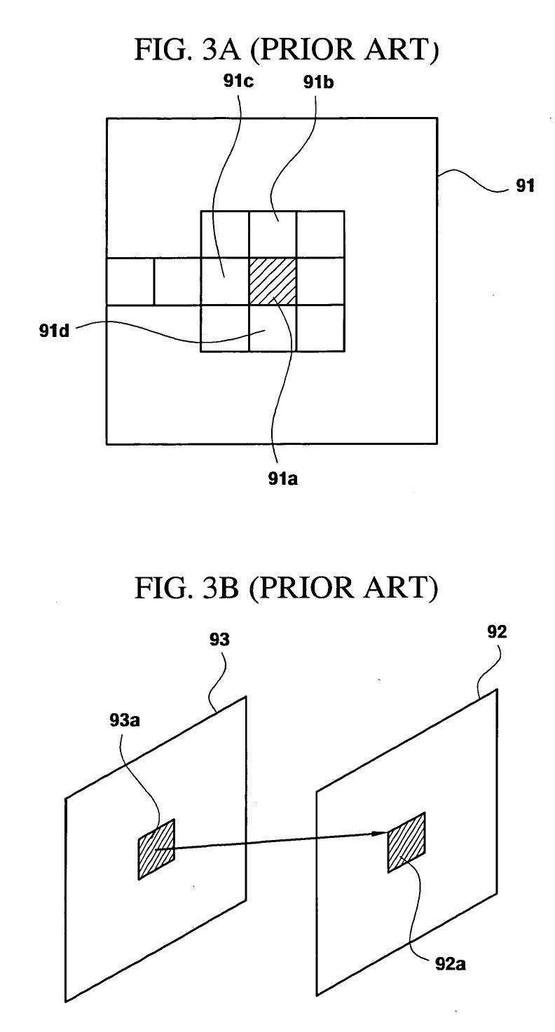

### DETAILED DESCRIPTION OF THE PREFERRED EMBODIMENT

The present invention will now be described more fully with reference to the accompanying drawings, in which exemplary embodiments of the invention are shown.

In general, when an error occurs in a macro block of a video frame, an error concealing method of detecting and concealing the error is used.

Error concealing methods can be categorized into a spatial error concealing method and a temporal error concealing method.

In the spatial error concealing method, when at least one macro block among upper, lower, left, and right macro blocks of an error-containing macro block is normal in a video frame, the normal macro block is copied or bilinear interpolation is performed based on the pixel distance between the adjacent macro blocks of the error-containing macro block.

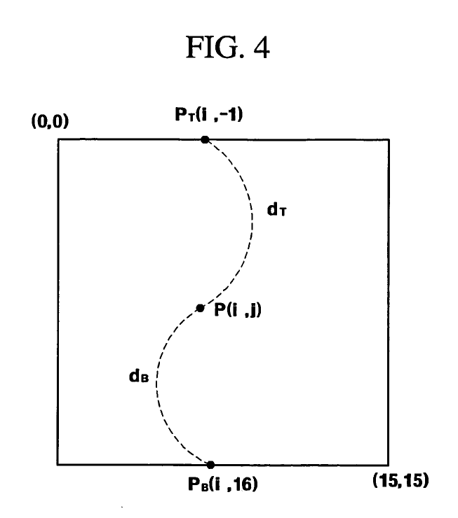

An interpolation method based on the pixel distance between an upper macro block and a lower macro block of an error-containing macro block will now be described with reference to FIG. 4. Referring to FIG. 4, the pixel coordinates of an error-containing macro block is P(I,j). In this case, the interpolation of the coordinates is performed based on Equation 1.

$$P ( i , j ) = \frac{1}{{d}_{T} + {d}_{B}} \times ( {d}_{B} {p}_{T} ( i , - 1 ) + {d}_{T} {p}_{B} ( i , 16 ) ) \qquad [ Equation 1 ]$$

wherein the macro block is a 16×16 sized block used as a unit of motion compensation coding, and T and B in Equation 1 denote top and bottom, respectively.

In addition, the temporal error concealing method performs motion compensation by applying motion vectors of the adjacent macro blocks of the error-containing macro block to the error-containing macro block.

After performing the motion compensation, the differential sum of adjacent pixels is calculated based on the boundary of the macro blocks in order to determine whether the motion compensation is appropriate.

In the case of the spatial error concealing method, an image is inevitably deteriorated in a vertical direction within an error concealed area. In the case of the temporal error concealing method, the deterioration of an image is inevitably generated in horizontal/vertical directions within an error concealed macro block.

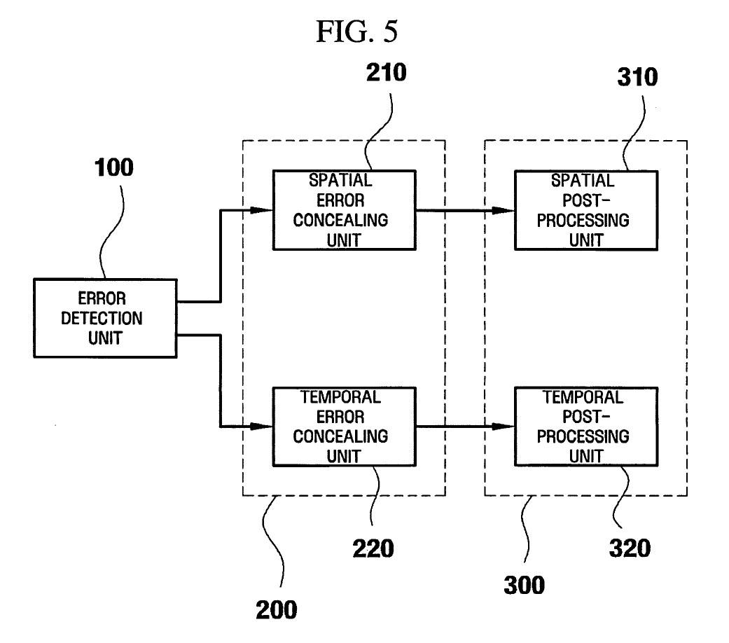

Thus, an error concealing device according to an exemplary embodiment of the present invention is provided to smooth the deterioration of images in horizontal/vertical directions after concealing errors. FIG. 5 shows an error concealing device according to an embodiment of the present invention, the error concealing device includes an error detection unit 100, an error concealing unit 200, and a video post-processing unit 300. The error detection unit 100 detects an error, and the error concealing unit 200 conceals the error detected by the error detection unit 100 by the spatial error concealing method or the temporal error concealing method based on the picture type of video frames. The video post-processing unit 300 smoothes horizontal/vertical edges of an error concealed video frame.

The error concealing unit 200 includes a spatial error concealing unit 210, which conceals an error by the spatial error concealing method, and a temporal error concealing unit 220, which conceals an error by the temporal error concealing method.

The spatial error concealing unit 210 and the temporal error concealing unit 220 are selected based on the picture type of the video frames.

In other words, an error in an I-type picture is concealed using the spatial error concealing unit 210, and errors of P-type and B-type pictures are concealed using the temporal error concealing unit 220.

In addition, the spatial error concealing unit 210 and the temporal error concealing unit 220 may be selectively used when the picture type of the video frames is continuously changed.

For example, when the present video frame is a P-type picture or a B-type picture, the spatial error concealing unit 210 performs error concealing and it is determined whether the error concealing is successful based on the matching of the error-containing macro block.

If the error concealing fails, the temporal error concealing unit 220 performs error concealing.

On the other hand, when the present video frame is an I-type picture and the prior video frame is a P-type or B-type picture, the temporal error concealing unit 220 performs error concealing, and it is determined whether the error concealing is successful based on the matching of the error-containing macro block. If the error concealing fails, the spatial error concealing unit 210 performs error concealing.

As described above, since the spatial error concealing unit 210 and the temporal error concealing unit 220 are selectively used based on the picture type of the video frames, errors under various conditions may be concealed.

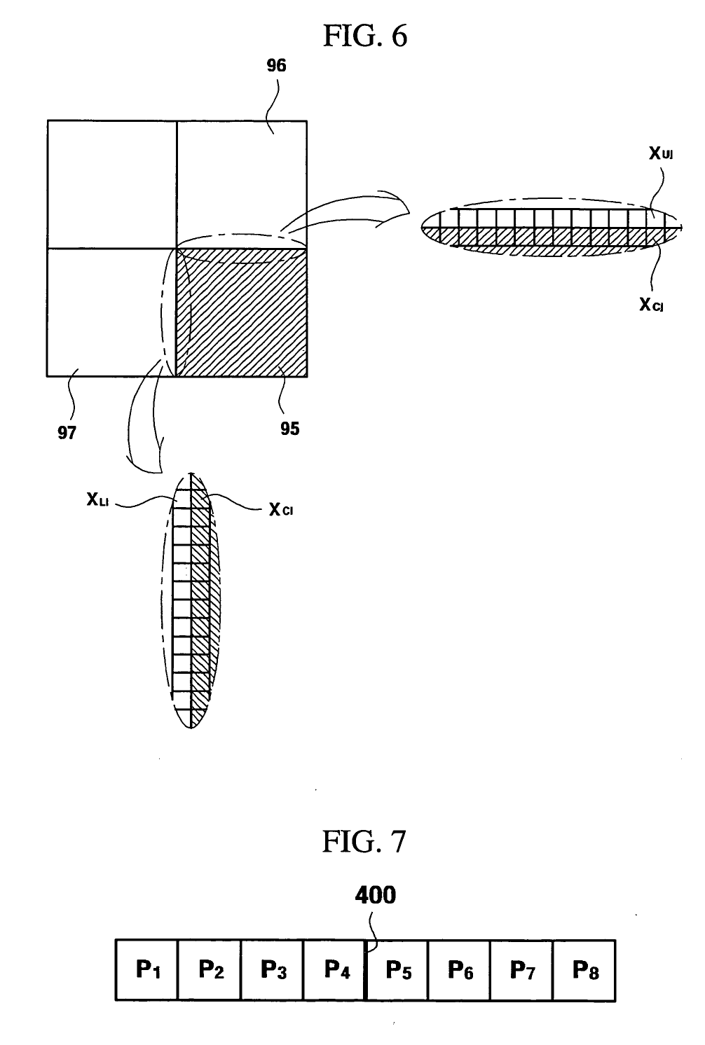

The matching may be calculated by differentially summing pixels of the upper and left macro blocks 96 and 97 that are adjacent to the boundaries of an error-containing macro block 95 to upper and left macro blocks 96 and 97, as shown in FIG. 6.

In an embodiment of the present invention, the matching is calculated by differentially summing the adjacent pixels above and to the left of the error-containing macro block 95; however, the matching may be calculated for the upper, lower, left, and right boundaries of the error-containing macro block 95.

Such a differential sum may be calculated by using

$$\frac{\sum \vert {X}_{Li} - {X}_{Ci} \vert + \sum \vert {X}_{Uj} - {X}_{Cj} \vert}{2} .$$

In this formula, C denotes an error concealed macro block, L denotes a macro block located at the left of an error-containing macro block, and U denotes a macro block located above of the error generated macro block.

Meanwhile, the video post-processing unit 300 includes a spatial post-processing unit 310 and a temporal post-processing unit 320. The spatial post-processing unit 310 smoothes vertical edges generated in a video frame whose error is concealed by the spatial error concealing unit 210. The temporal post-processing unit 320 smoothes horizontal/vertical edges generated in a video frame whose errors are concealed by the temporal error concealing unit 220.

In addition, the spatial post-processing unit 310 may smooth the horizontal edges in a case where the spatial error concealing unit 210 conceals an error using macro blocks located at the left and right of an error generated macro block.

An example of smoothing vertical edges in the spatial post-processing unit 310 will now be described.

The spatial post-processing unit 310 performs smoothing when the differential sum of the adjacent pixels in an error-containing macro block exceeds a reference value after the spatial error concealing unit 210 conceals the error.

In this case, the spatial post-processing unit 310 determines whether to perform the smoothing for Y, U, and V by the same method.

On the other hand, the temporal post-processing unit 320 performs smoothing when the average of a predetermined number of pixels, which are located at both sides of a horizontal/vertical boundary of an error-containing macro block, exceeds a reference value after the temporal error concealing unit 220 conceals the error.

For example, the average of the pixels P₁, P₂, P₃, P₄, P₅, P₆, P₇, and P₈, which are located at both sides of the boundary 400 of a macro block, is calculated, as shown in FIG. 7. The average may be calculated by using

$$abs ( \frac{{P}_{1} + {P}_{2} + {P}_{3} + {P}_{4}}{4} - \frac{{P}_{5} + {P}_{6} + {P}_{7} + {P}_{8}}{4} ) .$$

When the ratio of Y:U:V is 4:4:4, the temporal post-processing unit 320 calculates the average of the same number of pixels in view of a boundary for each of Y, U, and V. In addition, when the ratio of Y:U:V is 4:2:0 or 4:2:2, the temporal post-processing unit 320 calculates the average of four pixels for U and V while calculating the average of eight pixels for Y.

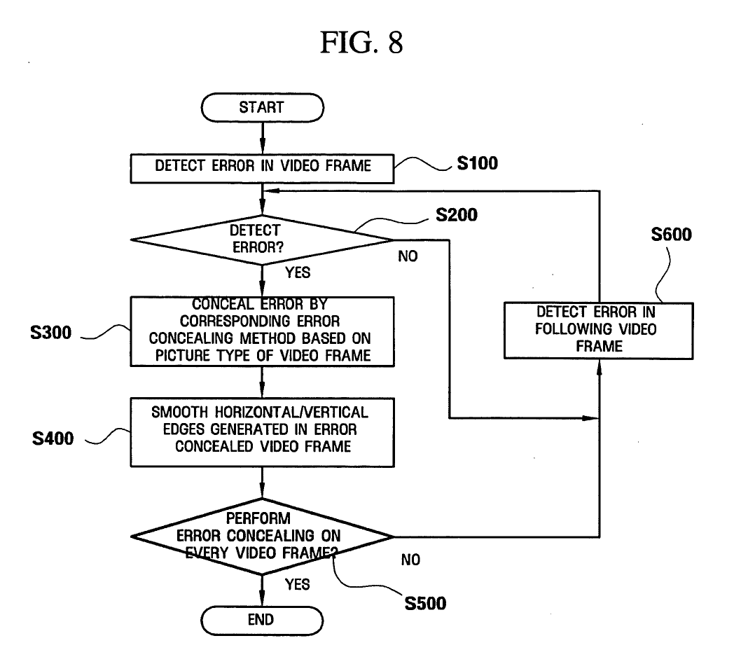

A method of concealing an error in video frames according to an embodiment of the present invention will now be described with reference to FIG. 8.

Referring to FIG. 8, an error existing in a present video frame is detected, in S100.

The detection of an error is performed by determining whether the syntax of a bit stream is correct or not, detecting a decoding error generated while decoding RF signals, which are received by a channel decoder, or examining the disharmony between a macro block and adjacent macro blocks in a video frame.

In S200, it is determined whether or not an error is detected in the present video frame. If no error is detected, then the process proceeds to detecting an error in the following video frame in S600. When it is determined in S200 that an error exists, then in S300, the picture type of the present video frame is determined to perform error concealing by selecting a proper error concealing method.

In other words, when the present video frame is an I-type picture, a spatial error concealing unit 210 performs the error concealing. When the present video frame is a P-type picture or a B-type picture, a temporal error concealing unit 220 performs the error concealing.

Thereafter, in S400 a post-process is performed based on the error concealing method used to conceal the error in the present video frame, in order to smooth horizontal/vertical edges in the video frame.

In other words, in the case where the error is concealed by the spatial error concealing unit 210 (FIG. 5), a spatial post-processing unit 310 performs smoothing. In the case where the error is concealed by the temporal error concealing unit 220, a temporal post-processing unit 320 performs smoothing.

In the illustrative embodiment of the present invention, the spatial post-processing unit 310 smoothes vertical edges that occur due to error concealing, which is performed by the spatial error concealing unit 210 by using the upper and lower macro blocks of the error-containing macro block, and the temporal post-processing unit 320 smoothes horizontal/vertical edges.

In this case, the spatial post-processing unit 310 and the temporal post-processing unit 320 determine whether to perform the smoothing based on the differential sum and the average of the error-containing macro block and the adjacent macro blocks, after concealing the error.

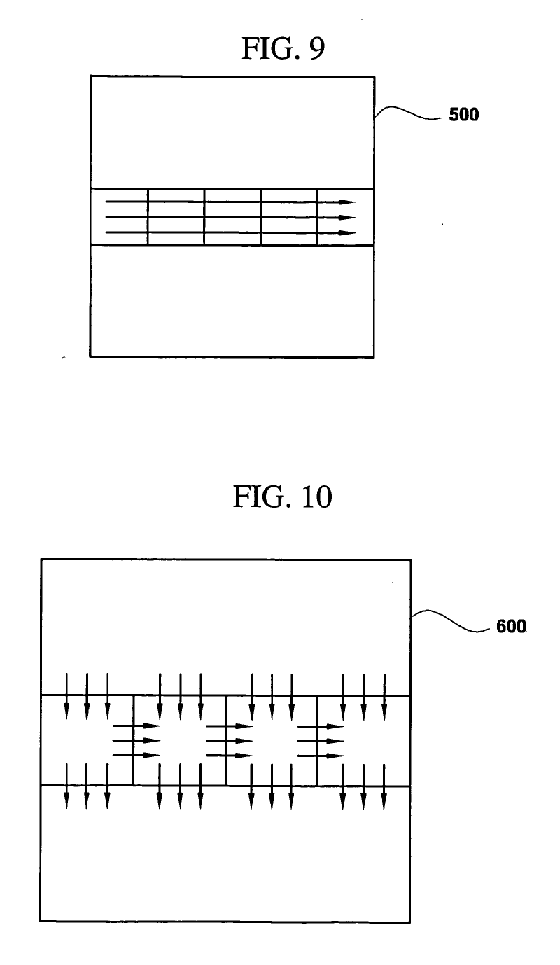

In other words, the differential sum Pₙ^{diff} is obtained by

$${P}_{n}^{diff} = {\sum }_{k = 0}^{a} \vert {P}_{n + k} - {P}_{n + k + 1} \vert > T1 ,$$

wherein n=0, 8, 16, 32, . . . . In addition, n denotes an n^{th} pixel for performing smoothing filtering, a denotes the number of pixels for obtaining a difference, and T1 denotes a reference value for performing the smoothing. When the differential sum exceeds T1, the smoothing is performed on an error-containing macro block 500 in a horizontal direction to smooth vertical edges due to error concealing, as shown in FIG. 9.

In addition, the average P_{abs} is obtained by the following equation:

$${P}_{abs} = \frac{{P}_{1} + … + {P}_{n / 2}}{n / 2} - \frac{{P}_{\frac{n}{2} + 1} + … + {P}_{n}}{n / 2} > T2$$

wherein n denotes the number of pixels for performing deblocking filtering with reference to horizontal/vertical directions of the error-containing macro block, and T2 denotes a reference value for performing the smoothing.

Accordingly, when the average exceeds T2, the smoothing is performed on an error-containing macro block 600 in horizontal/vertical directions to smooth horizontal/vertical edges, as shown in FIG. 10. In this case, the pixel value Pₙ′, which is located at the horizontal/vertical boundaries of the error-containing macro block, is obtained by

$${P}_{n} = \frac{1}{b} {\sum }_{k = - c}^{c} {w}_{k} {P}_{n + k}$$

to perform the smoothing.

In the formula, n denotes an n^{th} pixel for performing horizontal or vertical filtering, wₖ denotes a weighting factor applied to the pixel, which is used in the smoothing filtering, and b denotes the sum of the weighting factors wₖ, in other words,

$$b = {\sum }_{- c}^{c} {w}_{k} .$$

In addition, 2c+1 is a smoothing filter coefficient.

In other words, when a 9-Tab filter is used in smoothing, the pixel value may be obtained through the weight values of the pixels, by using the weighting factor for each pixel, such as wₖ=112242211, as a filter coefficient. As a result, the values of b and c are 16 and 4, respectively.

In other cases, when a 7-Tab filter having a weight factor of wₖ=1112111 or a 5-Tab filter having a weight factor of wₖ=11111 is used, the result of the smoothing is better.

Thereafter, in S500 (FIG. 8) it is determined whether error concealing has been performed on every picture frame. If not, then in S600, the error detection is performed on the following picture frame until the error concealing has been performed on every picture frame. The error concealing and smoothing steps S200, S300 and S400 are repeatedly performed based on the picture type of the error-containing video frames.

While the present invention has been particularly shown and described with reference to an exemplary embodiment thereof, it will be understood by those of ordinary skill in the art that various changes in form and details may be made therein without departing from the spirit and scope of the present invention as defined by the following claims.

According to exemplary embodiments of the present invention, by using a predetermined error concealing method, an image of high quality is provided to users by smoothing horizontal/vertical edges generated after performing error concealing on an error-containing macro block of video frames.

1. An error concealing device comprising:
an error concealing unit concealing an error generated in a macro block of video frames by using a predetermined error concealing method; and
a video post-process unit smoothing at least one of horizontal and vertical edges, which are generated in error-containing video frames.

2. The error concealing device of claim 1, wherein the error concealing unit conceals an error using a spatial error concealing method and a temporal error concealing method based on the picture type of the video frames.

3. The error concealing device of claim 2, wherein the video post-processing unit performs smoothing of pixels in the error-containing macro block that have a differential sum exceeding a reference value against adjacent pixels when an error of the video frames is concealed by the spatial error concealing method.

4. The error concealing device of claim 2, wherein the video post-processing unit performs smoothing when a difference of averages of predetermined numbers of pixels, which are located at both sides of horizontal or vertical boundary between the error-containing macro block and the adjacent macro block, exceeds a reference value, when an error of the video frames is concealed by the temporal error concealing method.

5. The error concealing device of claim 3, wherein the differential sum Pₙ^{diff} is obtained by
$${P}_{n}^{diff} = {\sum }_{k = 0}^{a} \vert {P}_{n + k} - {P}_{n + k + 1} \vert > T1 , ( n = 0 , 8 , 16 , 32 , … ) ,$$
in which n denotes n^{th} pixel for performing smoothing filtering in an error concealed area by the spatial error concealing method, a denotes the number of pixels for obtaining the difference, and T1 denotes the reference value for performing the smoothing.

6. The error concealing device of claim 4, wherein the average P_{abs} is obtained by
$${P}_{abs} = \frac{{P}_{1} + … + {P}_{n / 2}}{n / 2} - \frac{{P}_{\frac{n}{2} + 1} + … + {P}_{n}}{n / 2} > T2 ,$$
in which n denotes the number of pixels for performing deblocking filtering with reference to horizontal/vertical directions of the macro block after the temporal error concealing, and T2 denotes the reference value for performing the smoothing.

7. The error concealing device of claim 5, wherein a pixel value Pₙ′ in a case where the smoothing and deblocking are performed horizontally or vertically is obtained by
$${P}_{n} = \frac{1}{b} {\sum }_{k = - c}^{c} {w}_{k} {P}_{n + k} ,$$
in which n denotes an n^{th} pixel for performing filtering horizontally or vertically, wₖ denotes a weighting factor applied to the pixel, which is used in the smoothing filtering, b denotes the sum of weighting factors wₖ, and is expressed as
$$b = {\sum }_{- c}^{c} {w}_{k} ,$$
and 2c+1 is a smoothing filter coefficient.

8. The error concealing device of claim 7, wherein the smoothing for the spatial error concealing method and the temporal error concealing method is selectively used based on the picture type of a corresponding video frame when the picture type of a present video frame is different from the picture types of a prior video frame and a following video frame.

9. A method of concealing errors for video frames, the method comprising:
concealing an error generated in a macro block of video frames by using a predetermined error concealing method; and
smoothing at least one of horizontal and vertical edges of the error-containing macro block.

10. The method of claim 9, wherein the concealing of the error is performed by a spatial error concealing method and a temporal error concealing method based on the picture type of the video frames.

11. The method of claim 10, wherein the smoothing of the horizontal/vertical edges includes:
calculating a differential sum of adjacent pixels in units of a predetermined number of pixels for the error-containing macro block when an error of the video frame is concealed by the spatial error concealing method; and
performing smoothing when the calculated value exceeds a reference value.

12. The method of claim 10, wherein the smoothing of the horizontal/vertical edges includes:
calculating a difference of averages for predetermined numbers of pixels located at both sides of horizontal/vertical boundaries between an error-containing macro block and the adjacent macro blocks when an error of the video frame is concealed by the temporal error concealing method; and
performing smoothing when the calculated value exceeds a reference value.

13. The method of claim 11, wherein the differential sum Pₙ^{diff} is obtained by
$${P}_{n}^{diff} = {\sum }_{k = 0}^{a} \vert {P}_{n + k} - {P}_{n + k + 1} \vert > T1 ,$$
(n=0, 8, 16, 32, . . . ), in which n denotes an n^{th} pixel for performing smoothing filtering in an error concealed area by the spatial error concealing method, a denotes the number of pixels for obtaining the difference, and T1 denotes the reference value for performing the smoothing.

14. The method of claim 12, wherein the average P_{abs} is obtained by
$${P}_{abs} = \frac{{P}_{1} + … + {P}_{\frac{n}{2}}}{\frac{n}{2}} - \frac{{P}_{\frac{n}{2} + 1} + … + {P}_{n}}{\frac{n}{2}} > T2 ,$$
in which n denotes the number of pixels for performing deblocking filtering with reference to horizontal/vertical directions of the macro block after the temporal error concealing, and T2 denotes the reference value for performing the smoothing.

15. The method of claim 13, wherein a pixel value Pₙ′ when the smoothing filtering and deblocking filtering are performed horizontally or vertically is obtained by
$${P}_{n}^{′} = \frac{1}{b} {\sum }_{k = - c}^{c} {w}_{k} {P}_{n + k} ,$$
in which n denotes an n^{th} pixel for performing filtering horizontally or vertically, wₖ denotes a weighting factor applied to the pixel, which is used in the smoothing filtering, b denotes the sum of weighting factors wₖ and is expressed as
$$b = {\sum }_{- c}^{c} {w}_{k} ,$$
and 2c+1 is a smoothing filter coefficient.

16. The method of claim 15 further comprising:
determining whether the picture type of a present video frame is same as the picture types of prior and following video frames; and
selectively using the smoothing filtering for the spatial error concealing method and the smoothing filtering for the temporal error concealing method when the picture types of the video frames are different.

17. The error concealing device of claim 6, wherein a pixel value Pₙ′ in a case where the smoothing and deblocking are performed horizontally or vertically is obtained by
$${P}_{n}^{′} = \frac{1}{b} {\sum }_{k = - c}^{c} {w}_{k} {P}_{n + k} ,$$
in which n denotes an n^{th} pixel for performing filtering horizontally or vertically, wₖ denotes a weighting factor applied to the pixel, which is used in the smoothing filtering, b denotes the sum of weighting factors wₖ, and is expressed as
$$b = {\sum }_{- c}^{c} {w}_{k} ,$$
and 2c+1 is a smoothing filter coefficient.

18. The method of claim 14, wherein a pixel value Pₙ′ when the smoothing filtering and deblocking filtering are performed horizontally or vertically is obtained by
$${P}_{n}^{′} = \frac{1}{b} {\sum }_{k = - c}^{c} {w}_{k} {P}_{n + k} ,$$
in which n denotes an n^{th} pixel for performing filtering horizontally or vertically, wₖ denotes a weighting factor applied to the pixel, which is used in the smoothing filtering, b denotes the sum of weighting factors wₖ, and is expressed as
$$b = {\sum }_{- c}^{c} {w}_{k} ,$$
and 2c+1 is a smoothing filter coefficient.

19. The error concealing device of claim 1, wherein said video post-process unit smoothes vertical edges if a spatial error is concealed by said error concealing unit.

20. The error concealing device of claim 1, wherein said video post-process unit smoothes horizontal/vertical edges if a temporal error is concealed by said error concealing unit.

21. The method of claim 9, wherein vertical edges are smoothed if a spatial error is concealed.

22. The method of claim 9, wherein horizontal/vertical edges are smoothed if a temporal error is concealed.
